(19) United States
(12) Patent Application Publication
(10) Pub. No.: US 2003/0111005 A1
(43) Pub. Date: Jun. 19, 2003

(54) Wearable diet counter

(76) Inventors: Gregory Lord, Leesville, LA (US); Angelle Lord, Leesville, LA (US)

Correspondence Address: PHARMACEUTICAL PATENT ATTORNEYS, POHL & ASSOC., 55 MADISON AVENUE, 4TH FLOOR, ATTN: MARK POHL (P 4014), MORRISTOWN, NJ, 07960-6397, US

(21) Appl. No.: 10/025,162

(22) Filed: Dec. 19, 2001

(51) Int. Cl. G09F 9/00

(52) U.S. Cl. 116/307

(57) ABSTRACT

A wearable dietary-intake counter for counting and tracking dietary intake of foods.

### CROSS REFERENCES

None.

### GOVERNMENT RIGHTS

None.

### BACKGROUND

Weight control presents a major public health concern in the United States and, increasingly, abroad as well. Weight-control programs optimally include keeping one's dietary intake of calories and nutrients within certain pre-established boundaries. This is typically done by strict record keeping of daily intake. This approach works well for those with the ability to plan, control and record their daily diet. This approach is, however, less practical for those of us who aren't willing to dictate our daily menu in advance or who find daily recording of intake inconvenient. For example, daily recording is difficult to adhere to when dining regularly at restaurants or when one is pressed for time or simply when when one is not motivated to record daily habits.

It would thus be valuable to have a way to measure dietary intake as the day progresses. This enables anyone interested in better health to track and adjust their remaining daily diet based on food choices they've already made earlier in the day.

We have found a way.

### SUMMARY

Our invention entails incorporating a portable, convenient-to-use diet consumption counter onto a discreet jewelry base. This combination motivates the user to continuously record their dietary consumption as they dine, enabling healthier food choices throughout the day.

### THE DRAWINGS

FIG. 1 shows an isometric view of my currently-preferred embodiment, a bracelet with a diet consumption counter mechanism.

FIG. 2 shows an isometric view of an alternative embodiment of my invention, a ring or bracelet with a diet consumption counter mechanism.

Diet Consumption Counter

One element of our invention is a “diet consumption counter.” We use the term “diet consumption counter” to mean a counter to count one's dietary consumption. The counter may thus count the number of calories consumed, or the number of servings of each basic food group consumed, or the amount of each type of biochemical (protein, carbohydrate or fat) consumed. The important thing is that the counter count a quantity or aspect of dietary consumption.

While alternatives are possible, we prefer the counter count the servings of each basic food group consumed. When used with a standardized serving size, this measures approximate caloric intake (i.e., one serving from the meat group contains, on average, x kilocalories of energy; measuring the number of meat group servings consumed thus also measures the approximate calories consumed). This also measures approximate nutritive intake (i.e., one serving of red meat contains, on average, y milligrams of vitamin B₁₂; measuring the number of servings of red meat consumed thus also measures the approximate amount of vitamin B₁₂ consumed). Measuring the number of servings of each food group consumed is also easy. Measuring approximate calories consumed, requires the user to calculate the number of calories in each meal.

One of the most valuable aspects of our invention, however, is its motivational aspect. Unlike a simple diet diary booklet, using our invention creates a game-like environment that we have found aids the user to comply with the prescribed diet regime. The user learns, in a short time, that eating the correct portions from each food group can be challenging. The user's desire to “move all of the beads by the end of the day” and to thus “play the game” motivates the user to eat more fruit and vegetable servings and fewer meat and fat servings than the average American. The wearer is motivated to “win the game” by moving the beads.

The counter must include an indicator to indicate the amount of consumption. The indicator should be readily operable, so that the user may update it during mealtimes to register consumption accurately. Other than this, the selection of a specific type of indicator is simply a design choice. Thus, for this purpose, color-coded jewels or plastic buttons, an electronic display, a numerical display, or another indicator might be used.

We prefer the diet consumption counter be calibrated to display a pre-fixed target or maximum amount of daily dietary consumption. One could conceivably use a counter with amounts for another time period (e.g., weekly recommended amounts), or a counter having an arbitrary maximum countable quantity, or even no maximum (e.g., as with an electronic counter). With these, however, the counting mechanism might become less convenient to read and interpret.

We talk here about dietary intake of food, because we are concerned with maintaining healthy body weight and preventing many disease processes related to little or no intake of immune system enhancing phytochemicals found in fruits, vegetables, whole grains and beans. The use of our device is not strictly so limited, however.

We use the term “consumption counter” to mean a counter of consumption. Excluded from the term “consumption counter” are counters for measuring things other than consumption; thus, excluded from the term “consumption counter” are counters for measuring altitude, time, medical data (e.g., blood pressure, blood glucose levels, blood drug-concentration levels), environmental radiation, and other non-consumption related information, for example.

In contrast, included in the term “consumption counter” are counters for any kind of consumption, be it the consumption of food, or of non-food items such as cigarettes and medicines. For example, a “smoking consumption counter” is a counter which measures smoking by, for example, measuring cigarette or cigar consumption by measuring the number of cigarettes the user smokes during a certain time interval.

Similarly, a “medication consumption counter” is a counter which measures medication consumption by measuring the number of doses of a given medication the user takes during a certain time interval. For example, a medication counter could count the number of doses of insulin taken by a diabetic user during a given time period.

In contrast, we use the term “diet consumption counter” to mean a counter of dietary consumption; i.e., consumption of diet items (foods and drinks), and expressly excluding consumption of non-foods such as cigarettes, pharmaceuticals and other non-food items.

Several types of counters may be used together. For example, a diabetic user may use both a medication consumption counter to measure the amount of insulin taken in a given time period, and a dietary consumption counter to measure the amount and type of various foods consumed.

Jewelry Base

The diet consumption counter is made conveniently and discreetly available for use by mounting it on a jewelry base. Any type of jewelry may be used, including earrings, a necklace, an anklet or a bracelet. We prefer the last, as it provides easy to use dimension and is conveniently and discreetly accessible during mealtimes for the user to record their dietary consumption.

Use

The device is worn by the user, and used to measure dietary consumption throughout the day.

Thus, the user puts on the device in the morning and sets the diet consumption counter to zero. When the user eats breakfast, the user registers on the diet consumption counter what was eaten for breakfast (e.g., the total number of calories consumed or the number of servings of each basic food group consumed).

Later, as the user eats lunch, the user registers what was eaten for lunch (e.g., the total number of calories consumed or the number of servings of each basic food group consumed). The user's cumulative total dietary intake is thus tracked on an ongoing basis during the day, so that the user can readily see how much was already eaten, and what—if anything—remains to be consumed.

### DETAILED DESCRIPTION

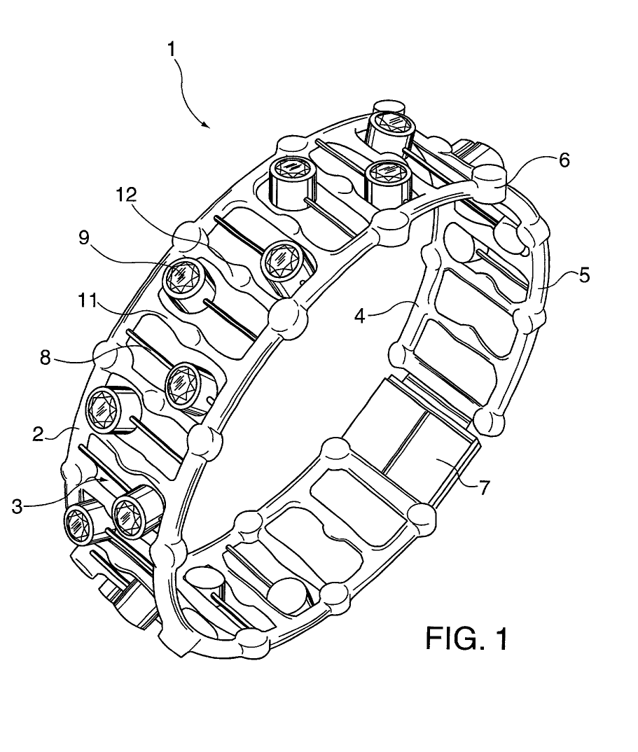

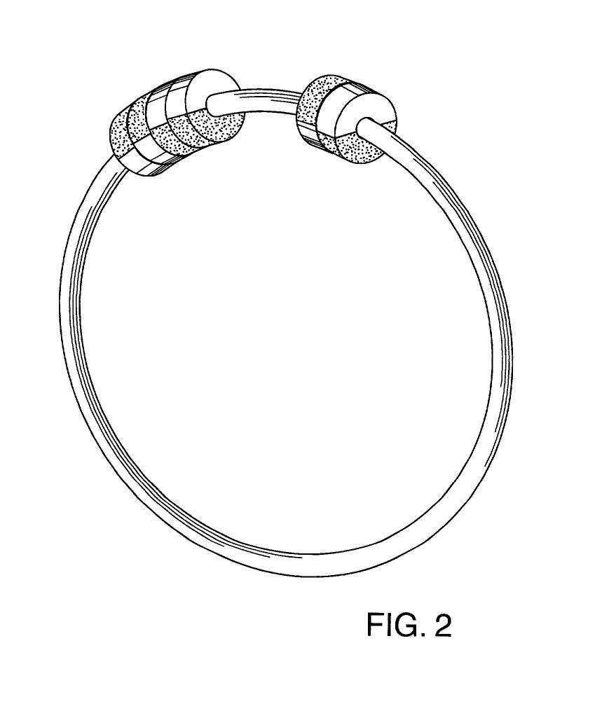

Here is how you can make our preferred embodiment, illustrated at FIG. 1. An alternative is shown at FIG. 2. My currently-preferred embodiment [1] of our invention entails two parts: 1) a bracelet jewelry base [2]; and 2) a diet consumption counter [3] for counting consumption of food groups.

Jewelry Base

Any type of jewelry may be used as a base. We prefer a bracelet. This is because a bracelet is both accessible during mealtimes, and provides adequate size to mount a dietary counter of significant size. We prefer a metal bracelet made of a first hoop [4], and prefer to include a second hoop [5] to make the device stronger. We prefer the bracelet provide a rigid support for my preferred version of the dietary counter. Thus, we prefer the first hoop [4] and second hoop [5] be made of solid metal segments. These segments are movably connected to each other by a plurality of hinges [6]. These hinges [6] enable the hoops [4, 5] to be opened to ease the user's putting the bracelet on and taking it off. A closing clasp [7], as is known in the art, keep the hoops closed around the user's wrist when the device is being worn.

Alternatively, one could use another type of jewelry base. FIG. 2 shows a device comprising a ring or bracelet. Anklets, earrings and necklaces might alternatively be used, albeit they can be less convenient and more conspicuous to access during mealtimes.

For adults, we prefer the device be made of jewelry-grade materials such as plated metal. One may of course use different materials. For example, one may make an inexpensive version of our device using rubber or plastic, perhaps for children of for sports and casual wear.

Diet Consumption Counter

Our invention requires the jewelry base, in whatever form, have a “diet consumption counter.” In our preferred embodiment, the counter is made from a plurality of pins [8]. The pins [8] connect at one end to the first hoop [4], and at the other end to the second hoop [5].

Each pin [8] supports an indicator [9]. We prefer the indicator to be made from a jewel mount [10] which mounts a jewel. One might make a less expensive version with the indicator [9] made of colored plastic or rubber, dispensing with the need for a separate colored jewel. The indicator [9] is laterally displaceable or movable along the length of the pin [8] from the first end of the pin to the second end of the pin. Movement of the indicator [9] is restricted by including a rubber bushing to grip the pin [8], so that the indicator [9] only moves when the wearer intentionally pushes it; otherwise, the indicator [9] will stay in place.

Movement of the indicator [9] is further restricted by providing alongside the pin [8] a spacer bar [11] which interferes with the lateral movement of the indicator [9]. We prefer the spacer bar [11] have a nub [12] for this purpose, but this is simply a design choice; various size and shape spacer bars will suffice.

We prefer to provide indicators [9] in a number of colors, color-coded for various types of food groups. This is simply a design choice, however. One might just as well provide monochromatic jewels with graphic icons symbolizing food groups, or use different size icons for different food groups. Similarly, one could provide not a food-group counter, but a calorie-counter. So doing, the indicators [9] would signify the quantity of calories consumed. We also prefer to place one indicator on each pin. This is simply a design choice, however, as one might put all green (vegetable) indicators on one pin, all red (meat) indicators on another pin, etc . . . .

We prefer to classify foods into the following groups: milk; meat; vegetable; fat; fruit; and bread. Accordingly, one may, for example, use grey jewels to denote dairy, red jewels to denote meat, green jewels to denote vegetable, yellow jewels to denote fat, and so forth.

We prefer to provide, for each color, the number of indicators [9] one would see in a well-balanced daily diet based on the food pyramid, the American Dietetic Association recommendations and the American Diabetic Association's recommended diabetic diet. For example, if a well-balanced diet includes two servings each of milk and meat, and five servings of vegetables, we prefer to use only two grey and two red indicators [9], and five green indicators [9]. The number is, however, a discretionary design choice. One could provide more, enabling the user to monitor over-eating. Similarly, one could use various numbers tailored to specific diets; e.g., an “athlete” device coding a high-protein diet with more milk and meat icons, a “cold & flu” device with no dairy icons at all, mens' and womens' diets, childrens' diets, and so forth.

We believe activity—both physical and spiritual is important in maintaining a healthy lifestyle. Thus, we also prefer to include indicators [9] to count or register both daily physical activity (exercise) and spiritual activity (reading one's Holy Book).

Use

The device is worn by the user, and used to measure dietary consumption throughout the day. The user puts on the device in the morning and sets the diet consumption counter to zero, by moving each indicator [9] laterally along the pin [8] to the first end of the pin, adjacent to the first hoop [4]. Because the indicators [9] each have a rubber bushing, the rubber bushing [7] grips the pin [8], preventing accidental lateral displacement of the indicators [9] until they are manually displaced. Similarly, the spacer bar [11] prevents accidental displacement of the indicators [9].

When the user eats breakfast, the user registers on the diet consumption counter what was eaten for breakfast. This is done by pushing the relevant numbers of the relevant color-coded indicators [9] laterally along the pin [8] from the first end of the pin to the second end of the pin, adjacent the second hoop [5]. For example, if the user's breakfast includes a serving of orange juice, a serving of unbuttered toast, a serving of eggs and a serving of ham, the user would move four indicators [9]; one each for fruit and bread, and two for meat. The user would push each of these four indicators [9] along the pin [8] from the first end to the second end, registering dietary consumption. Because the indicators [9] each have a rubber bushing, the rubber bushings grip the pins [8], keeping the four indicators [9] in place at the second end of the pin throughout the day.

Later, as the user eats lunch, the user registers what was eaten for lunch. This is done by moving the relevant quantity of the correct kinds of indicators [9] along the pins [8] from the first end of the pinto the second end.

The user's cumulative total dietary intake is thus tracked on an ongoing basis during the day, so that the user can readily see how much of what was already eaten, and what—if anything—remains to be consumed.

It is important that the user register dietary intake on the counting device properly. Thus, we prefer to provide the user with a “key” or legend defining certain dietary information. For example, serving size is important. The purpose of the device can be frustrated if the user's serving sizes are exaggerated. Thus, the key provides information on how to measure appropriate serving sizes for various foods and food groups. Similarly, food type classification is important. For example, we classify corn as a member of the bread group, not as a member of the vegetable group. The key provides this kind of definitional information, so that the user may properly and accurately register their correct consumption.

An Alternative Embodiment

Our device may of course be made in various embodiments. We show an alternative embodiment in FIG. 2.

In this version, the jewelry base is a bracelet, necklace or earring. The jewelry base mounts a diet consumption counter. The diet consumption counter is made from a number of indicator discs mounted on the jewelry base. Each indicator has two faces (no consumption and consumption), and is color-coded to designate a specific food group. The indicator discs are each rotatable to show either of the two faces.

To use the device, the indicators are each rotated to their pre-consumption or start-of-day position. During the day, the user rotates the appropriate number of the relevant indicators, to measure dietary consumption.

### SUMMARY

In our claims, we use the singular to include the plural (i.e., “a” or “an” means “one or more”).

The present invention is not to be limited in scope by the specific embodiments disclosed in the examples which are intended as illustrations of a few aspects of the invention and any embodiments which are functionally equivalent are within the scope of this invention. Indeed, various modifications of the invention in addition to those shown and described herein will become apparent to those skilled in the art and are intended to fall within the scope of the invention. We thus intend the legal coverage of my patent to be defined not by the specific examples included here, but by the legal claims appended here.

We claim:

1. A wearable counter comprising:
a. a first hoop;
b. a second hoop;
c. a pin with a first end and a second end, said pin attached at said first end to said first hoop, said pin attached at said second end to said second hoop; and
d. an indicator, said indicator displaceably mounted on said pin, such that said indicator may be displaced from said first end of said pin to said second end of said pin.

2. The wearable counter of claim 1, further comprising:
e. a brace with a first end and a second end, said brace attached to said first hoop at said first end, said brace attached to said second hoop at said second end, said brace positioned to reduce unintended displacement of said indicator along said pin.

3. The wearable counter of claim 1, wherein said indicators are provided in a quantity equal to the number of daily recommended servings of each food group.

4. In a method of controlling body weight by limiting dietary consumption, the improvement comprising:
a. providing an apparatus comprising a jewelry base mounting a diet consumption counter.

5. The method of claim 4, further comprising:
b. recording diet consumption on said diet consumption counter.

6. In a method of controlling smoking by limiting smoking, the improvement comprising:
a. providing an apparatus comprising a jewelry base mounting a smoking consumption counter.

7. The method of claim 6, further comprising:
b. recording smoking consumption on said smoking consumption counter.

8. In a method of administering a medication, the improvement comprising:
a. providing an apparatus comprising a jewelry base mounting a medication consumption counter.

9. The method of claim 8, further comprising:
b. recording medication consumption on said medication consumption counter.

10. The method of claim 8, wherein said apparatus further comprises a dietary consumption counter.

11. A wearable diet consumption counter comprising:
a. a jewelry base, mounting
b. a diet consumption counter.

12. The wearable counter of claim 11, wherein said diet consumption counter comprises a plurality of displaceable indicators.

13. The wearable counter of claim 11, wherein said jewelry base is a bracelet.

14. The wearable counter of claim 13, wherein said diet consumption counter comprises a plurality of displaceable indicators.

15. The wearable counter of claim 14, wherein said displacable indicators are provided in a quantity equal to the number of daily recommended servings of each food group.
